(19) United States
(12) Patent Application Publication
(10) Pub. No.: US 2008/0257898 A1
(43) Pub. Date: Oct. 23, 2008

(54) Dieter's water intake quantity tracking vessel

(76) Inventor: Michael J. Pollio, Long Valley, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/788,583

(22) Filed: Apr. 20, 2007

(51) Int. Cl. A47G 19/22; G09F 9/37

(52) U.S. Cl. 220/703; 116/324

(57) ABSTRACT

A drinking vessel for dieters keeps track of water consumed during a 24-hour period using liquid level markers for 4, 8, 16 or 24 ounce water consumption. The vessel is preferably a glass having an integrally attached T cross section ring over which is moved a rider carrying a marker that points to an indicia on the glass outer surface The rider has a V shaped projection that engages with one of a plurality of notches present on the upper surface of the T cross section ring. Engagement between the rider and the V shaped projection is secured by a spring within the rider, preventing accidental displacement thereof. The user drinks water, pushes the rider upwards to clear the projection of the rider from the notch of the ring, and advances the rider according to volume of water consumed. The position of rider tracks the volume of water consumed during a 24-hour period. The rider may be removed and replaced after cleaning the drinking glass. Tracking of water consumption remains accurate and reliable over a prolonged period of time despite repeated cleaning of the vessel in domestic or commercial dishwashers.

### BACKGROUND OF THE INVENTION

1. Field of the Invention

The present invention relates to drinking vessels; and more particularly, to a washable glass or a cup that monitors water consumption by tracking the number of glasses of water consumed during a 24-hour period, thereby helping a dieter achieve weight loss goals.

2. Description of the Prior Art

The quantity of water consumed during a 24-hour period is known to have a significant effect on the weight loss that may be achieved by a dieter. Excessive consumption of proteins, or diuretics such as coffee or tea, contributes to loss of body fluids, which need to be replaced in order to promote weight loss. Many patents address issues related to monitoring devices that track liquid intake. Such devices have complex mechanisms that are prone to accumulation of debris or hinder the dieter's ability to comfortably hold a cup containing water appointed for fluid intake.

U.S. Pat. No. 261,131 to Bonshire discloses a jelly jar. During molding the jelly jar is provided with a plurality of imperishable molded labels, which may be revealed through a clear panel to show one of the names molded to indicate the jelly jar's contents. The jar disclosed by the '131 patent is not a drinking glass; and it does not keep track of the amount of water consumed during a 24-hour period.

U.S. Pat. No. 2,739,564 to North discloses an elongated pocket size two-element dose-time-indicating container. This device tracks the time of day that a capsule or pill is taken by the patient. Indicia are formed on the cylindrical outer surface of the container. The cap portion has a notch like opening through which numerals and time indicating marks may be viewed. This pocket-size device is for capsules or pills; it has insufficient volume to measure and record the amount of drinking water consumed by a dieter.

U.S. Pat. No. 3,574,957 to Bello-Bridick discloses an educational tumbler. This tumbler has a tubular shape, with tapered sidewalls that are provided with a plurality of rotatable bands forming different levels. Each band carries indicia such as pictorial, alphabetic or numerical characters which, when properly placed in vertical alignment, represent a meaningful relationship. The indicia on the bands do not facilitate tracking of water consumed by the user during a one-day period.

U.S. Pat. Nos. 4,345,541 and 4,405,045 to Villa-Real disclose a mono-ringed rotatory medication reminder and an automatic two-component medication time-interval reminder cap and container. This is a simple mechanically manipulatable two-component inter-acting device for use as an effective medication-time-intake reminder. It has an attachable-detachable outer rotatory ring with a singular or a plurality of outer protrusions correspondingly engagable with a stationary flat circularly component having a running clocklike numeral indicia ranging from 1 to 12. Each respective rotatory ring has a fixed clockwise spacing interval between the “LAST DOSE” arrow indicia and the “NEXT DOSE” arrow indicia, depending upon the required application to accomplish the specific time interval in the administration of each corresponding particular medication. The indicia remind the user to take a dose of the medication, but do not keep track of the amount of water consumed by the user during a 24 hour period.

U.S. Pat. No. 4,621,670 to Yuen discloses a date indexed food storage container. This food container is adapted for use in a home freezer. It has a peripheral flange adjacent to the top of the container's lower portion. The flange is date indexed and extends outwardly. When the non-rotating top cover equipped with a pointer is fixed to the base, the indicia on the flange are visible from above. Such visibility of the indicia occurs at the same time as the viewers' eyes are directed down toward the food container. The storage freezer container disclosed by the '670 patent does not suggest a drinking glass; it does not keep track of water consumed by the user during a 24 hour time period.

U.S. Pat. No. 4,877,119 to Hosking discloses a drinking-beaker assembly. The assembly helps determine the precise amount of liquid consumed. It includes a beaker, a snap-ring collar, indicia for the number of uses and indicia for the volume level within the beaker. Portions of the wall define an annular groove having an upper rib, a bight and a lower rib. The collar is snugly fitted within the groove for manual, axial rotation of the collar relative to the beaker. A window disposed within the color is aligned with the use indicia to sequentially indicate the number of consumptive uses of the assembly. Accumulation of dirt tends to prevent the color from rotating freely; and the window tends to fog up and loose clarity during prolonged use. Rotation of the collar impairs gripping of the drinking beaker. Location of the window with respect to the indicia may be accidentally altered during grabbing of the cup by the user.

U.S. Pat. No. 4,951,596 to Wallace discloses indicating means for medication containers. This indicating device has the form of a holder for symbol elements. A body portion of the device is attached to a c-section clamp. The c-section clamp is adapted to be springingly engaged with an object appointed for connection to the device. Symbol elements are positioned along the body portion's guide track for selective alignment with a viewing aperture. This viewing aperture slides in a direction parallel to the face of the body portion so that each symbol element can be viewed individually. The c-clamp of the body of the indicator is attached to the medication container. The viewing aperture slides on a set of tracks on the body to expose symbols. The indicator forms no part of the medication container; but is, instead, a separate part. The medication container does not suggest a drinking glass, and the symbols do not track water consumption during a 24-hour period.

U.S. Pat. No. 5,607,078 to Nordberg et al. discloses a device for counting and measuring liquid consumption. This graduated drinking mug has a handle with a movable clip for keeping track of the number of refills in a first scale through a window in the clip and total volume consumed indicated using a pointer in a separate scale for a particular mug fill volume of 8 ounces per cup fill or 10 ounces per mug fill. This device is a mug not a drinking cup. Liquid consumption measurement is located in the handle used to hold the mug. Consequently, during use of the mug, the movable clip may be accidentally moved. The movable clip has a plurality of ears adapted to engage notches on both sides of the handle. Displacement of the clip to a next position requires that the clip be opened out in order that the ears clear the straight portion of the handle. The clip material is incapable of sustaining such opening extension will likely break during extended usage. The window used to observe the number of mug fills will likely become cloudy or opaque with repeated dishwasher cleanings. In order to keep track of liquid volume consumed, the user must drink a fixed quantity of water (either 8 ounces or 10 ounces). The measure of liquid consumption otherwise becomes unavailable, since the indicia tracks only the number of mug fills.

U.S. Pat. No. 5,881,597 to Brooks discloses a consumption indicator label apparatus, and methods of using same. An indicating device records consumption of a consumable substance during a time period. The device comprises a first member having an adhesive surface for temporary securement to a drinking container; a second member having a surface which is removably engaged with the first surface of the first member; and a plurality of peelable tab members, each of which is removably secured along a second surface of the first member. Each of the tab members includes a marking which is different from the other markings and which indicates an amount which has been consumed during the period. The number of glasses of liquid consumed is indicated by the next tab, which has, as yet not been peeled. Due to the use of the adhesive coated first member and peelable tabs, the drinking container is not intended for repeated usage to track a dieter's daily water consumption.

There remains a need in the art for a drinking glass for dieters that allows the user to reliably and repeatedly keep track of the amount of water consumed during a 24-hour period, and which can withstand repeated dishwasher cleaning without impairment of tracking accuracy.

### SUMMARY OF THE INVENTION

The present invention provides a drinking vessel for dieters that allows the user to reliably and repeatedly keep track of the amount of water consumed during a 24-hour period. Advantageously, the drinking vessel is easily held and used without inadvertently altering the tracking mechanism. Tracking accuracy is reliably maintained over a prolonged period of time despite repeated cleaning with domestic or commercial dishwashers.

The vessel, preferably a glass or cup, has a liquid volume mark indicating 4 oz and 8 oz markers or, in a second embodiment, a larger glass with 8 oz and 16 oz markers. The glass is generally cylindrically shaped, preferably having a tapered sidewall for a comfortable hand grasp during drinking of water. Each of these glasses has a base that is small enough to fit in a cup holder of a car or an SUV. A bottom portion of the cup has an integrally attached T cross section turned sideways ring attached to the sidewall, with the leg of the T contacting the sidewall. The location of the ring is sufficiently high that a drinking glass of either size can be readily secured in a cup holder of a car or an SUV. A detachable spring loaded U cross section rider that is turned sideways rides in this T cross section ring. The U shaped cross section is provided with two end projections, one on each side of the U. The space between the end projections is sufficient to clear the wide portion of the T cross section of the ring so that the rider may be inserted into the ring or removed from the ring at will. A series of V shaped notches on the top surface of the T cross section ring mate with a corresponding V shaped projection on the upper interior surface of the U cross section rider. The V shaped notches are positioned at equal distances apart and incrementally track the consumption of 4 ounce liquid amounts (approximately half of a full glass) consumed. The glass has indicia printed, raised, or embossed on its outer surface, representing the number of full glasses at full volume of liquid consumed. Such indicia bear labels 0, 1, - - - , 12, with each number being positioned over the corresponding V shaped notch. The drinking glass has a mark that clearly indicates a consumption goal of 8 cups, allowing the user to determine at a glance how many more cups must be consumed to reach the desired goal. Indicia designating full cup values are printed; and indicia designating half-cup values are left blank, to enhance visibility. A user of the dieter's drinking glass keeps track of the liquid consumed by sliding the rider manually to the next notch as the water in the glass is consumed. Each glass has means for tracking water consumed to a precision of 4 ounces, or half a cup, using these notches.

In the second embodiment, a taller, larger capacity drinking vessel, preferably a glass or cup, is provided with 8 ounce and 16 ounce markings. The bottom of the glass still has a small enough diameter to fit into the cup holder of a car or SUV. The drinking cup has integrally attached thereto a T cross section ring similar to the first embodiment. V shaped notches designate each 8 ounces consumed, and the glass bears indicia marked as 0, 8, 16, . . . , 64, 72. The indicia designated 64 is marked with a clear arrow indicating that this is the daily water consumption goal. With this arrangement, a user can look at the glass and discern at a glance the degree of progress achieved towards the water consumption goal.

In the third embodiment, a taller, larger capacity drinking vessel, preferably a glass or cup, is provided with 8 ounce, 16 ounce and 24 ounce markings. The bottom of the glass still has a small enough diameter to fit into the cup holder of a car or SUV. The drinking cup has integrally attached thereto a T cross section ring similar to the first embodiment. V shaped notches designate each 8 ounces consumed, and the glass bears indicia marked as 0, 24, 48 and 72. An indicia designated 64 is marked with a clear arrow indicating that this is the daily water consumption goal. With this arrangement, a user can look at the glass and discern at a glance the degree of progress achieved towards the water consumption goal.

A spring loaded rider with a pointer or an embossed or printed marker line is provided to ride smoothly on the T cross section ring and point to an indicia embossed or printed on the glass outer surface. A spring is provided on the bottom interior section of the U cross section rider, turned sideways. When the rider is inserted into the T section ring, the spring rests on the underside of the leg of the T cross section pushing the rider downwards. This permits the upper projection of the U cross section of the rider to enter behind the top of the T cross section of the ring, thereby preventing accidental removal of the rider from the T cross section ring. Moreover, the downward pushing action engages the V shaped projection of the rider with the V shaped notch of the ring, securing the rider at a user selected location. Advantageously, in use, the rider is held securely in place, and is not accidentally displaced, even by vigorous shaking of the drinking glass.

In order to move the rider to the next notch after consuming 4 ounces of water or moving the rider by two notches after consuming 8 ounces of water in the first embodiment, the user simply presses the rider upwards, using a finger or thumb. This upward pushing action of the rider displaces the V shaped projection of the rider toward the upper surface of the ring, clearing the V shaped notch of the ring and allowing it to be moved freely. In this position, the rider can be readily removed from the T section ring, at which point the rider may be tilted away from the drinking glass and slid off to facilitate cleaning of the drinking glass. The rider may be reinserted by following an opposite sequence, wherein the bottom projection is inserted first behind the T cross section ring and the spring is compressed until the bottom of the upper projection of the rider slides over the upper surface of the T cross section ring. With this arrangement, the rider can be removed by the user at any time during the 24-hour period for cleaning of the drinking glass and reinserted back into any of the notches, so that the user does not have to lose track of water already consumed.

Generally stated, the invention comprises in one embodiment a drinking glass provided with 4 ounce and 8 ounce markers. In a second embodiment, a drinking glass is provided with 8 ounce and 16 ounce markers. In a third embodiment, a drinking glass is provided with 8 ounce, 16 ounce and 24 ounce markers. The glass is provided with an integral T cross section ring turned sideways, with the leg of the T non-rotationally attached to the outer surface of the drinking glass. A removable rider with a U cross section that is turned sideways is inserted over the T larger dimension and is displaced to the next one or two notches, as the case may be, when water is consumed in units of 4 ounce or 8 ounce in the first embodiment, or 8 ounce and 16 ounce in the second embodiment or 8 ounce, 16 ounce or 24 ounce in the third embodiment. The water consumed is tracked by a marker on the rider pointing to printed, raised or embossed indicia on the drinking glass. Accidental movement of the rider is prevented by engagement of a V shaped projection in the rider that mates with one of a plurality of V shaped notches present in the upper surface of the T cross section ring by spring tension from a spring that is attached to the bottom interior surface of the U shaped cross section of the rider.

### BRIEF DESCRIPTION OF DRAWINGS

The invention will be more fully understood and further advantages will become apparent when reference is had to the following detailed description and the accompanying drawings, in which:

FIG. 1a is a schematic view of a dieter's water intake quantity tracking glass according to the first embodiment of the invention showing the drinking glass with 4 ounce and 8 ounce markers, the T cross section ring integrally attached to the glass with the U cross section rider placed on the ring;

FIG. 1b is a schematic view of a dieter's water intake quantity tracking glass according to the second embodiment of the invention showing the drinking glass with 8 ounce and 16 ounce markers, the T cross section ring integrally attached to the glass with the U cross section rider placed on the ring;

FIG. 1c is a schematic view of a dieter's water intake quantity tracking glass according to the third embodiment of the invention showing the drinking glass with 8 ounce, 16 ounce and 24 ounce markers, the T cross section ring integrally attached to the glass with the U cross section rider placed on the ring;

FIG. 2 illustrates a schematic view of the drinking glass with the T cross section ring showing the notches that are present on its upper surface;

FIG. 3a illustrates a cross section along XX of FIG. 1 showing the glass, T cross section ring and rider with a bent metal spring; and

FIG. 3b illustrates a cross section along XX of FIG. 1 showing the glass, T cross section ring and rider with a coil spring.

### DESCRIPTION OF THE PREFERRED EMBODIMENTS

Recent recommendations for dieters include consuming at least 8 glasses of 8-ounce plain water in a 24-hour time period. Moreover, consumption of diuretic liquids such as coffee or tea depletes water reserves of the body and additional plain water is needed for efficient kidney functionality. Consumption of alcohol also dehydrates the body and additional water is needed for proper metabolic activity. Consumption of large amounts of protein, a typical regime followed by dieters also requires a higher quantity of water for proper elimination of urea and nitrates produced within the body. There accordingly exists a strong need for dieters to keep precise track of the total volume of plain water consumed during a 24-hour period. Preferably such water consumption should approximate at least eight 8 ounce glasses of water. More water consumption is needed if coffee, tea or alcohol is consumed and if excessive amounts of protein are consumed. The present invention is directed to precisely tracking the exact amount of water consumed by the user during a 24-hour period. In accordance with the invention, there is provided a mechanically simple, easy to use drinking glass that has an indicating rider that can be quickly removed and replaced, thereby allowing the drinking glass to be thoroughly washed at any time. The construction of the drinking glass relatively uncomplex, so that no debris or salt residues collect in narrow spaces, and no windows are present to cloud up or become opaque progressively.

Generally stated, the dieter's drinking glass has two separable components. The first component is an easy to clean drinking glass with a permanently attached T cross section ring and the second component is a spring loaded rider with a U shaped cross section designed to slide on the T cross section ring. The user keeps track of the volume of water consumed in increments of 4 ounces by sliding the rider over the ring.

The first component is a drinking glass, preferably a tapered glass of a size greater than 8 ounces. The glass has etched, embossed, raised or printed marks drawn at liquid levels having a volume of 4 ounces and 8 ounces in the first embodiment and at liquid level volume of 8 ounces and 16 ounces in the second embodiment. For example, when the user fills the glass with water to this 4 ounce level, the glass is filled with exactly 4 ounces of water and similarly the 8 ounce or 16 ounce marker connotes filling to 8 or 16 ounces of water. In the first embodiment, the heights of the two marks of 4 ounces and 8 ounces are not at equal distances from the bottom of the drinking glass, since the cup sidewall is tapered. The sidewall of the drinking glass near its bottom portion is permanently attached to a T cross section ring with the leg of the T contacting the sidewall of the glass. This ring is fixed to the glass at a suitable height location so that the bottom of the glass fits in a cup holder of a car or SUV and the ring does not rotate. The large dimension of the T in this case is vertical and there is a gap present between the T cross section ring and the side of the glass forming an annulus facing the top of the glass and an annulus facing the bottom of the glass. The top of the T cross section is periodically notched with a V shaped notch and each consecutive V shaped notch represents an incremental consumption of 4 ounces of water. The outer surface of the drinking glass has etched, embossed, raised or printed indicia labels 1 through 12 at each alternate notch location in the first embodiment. The indicia at 8 cups water consumption is indicated by a goal marker.

The second embodiment is similar to the first embodiment, but it is a taller glass with a larger fluid volume capacity. The glass is marked with water level markers, marking 8 ounce and 16 ounce. The indicia are marked with 0, 8, 16, . . . , 64, 72 in the glass for tracking the amount of water consumed. The indicia at 64 ounces water consumption is indicated by a goal marker.

The third embodiment is similar to the first embodiment and the second embodiment, but it is an even taller glass with a larger fluid volume capacity. The glass is marked with water level markers, marking 8 ounce, 16 ounce and 24 ounce. The indicia are marked with 0, 8, 16, . . . , 64, 72 in the glass for tracking the amount of water consumed. The indicia at 64 ounces water consumption is indicated by a goal marker.

The rider has a U shaped cross section and the top of the U has two projections facing inwards. The space between the two projections is slightly larger than that is required to clear the T cross section ring and the U cross section rider may be slid over the ring easily. In use, the U cross section rider is turned sideways and the two projections are in a vertical plane. The bottom interior of the U cross section rider has a permanently attached spring. This spring may be a coil spring comprising a bent piece of metallic sheet or a polymeric spring. The spring is preferably made from stainless steel or other corrosion resistant material. The upper interior surface of the U cross section rider has a V shaped projection that has the same shape as the V shaped notch of the T cross section ring's upper surface. The rider has an etched embossed, raised, printed or projecting marker.

The rider is assembled over the T cross section ring by sliding the bottom projection of the U cross section rider into the bottom annulus of the T cross section ring so that the spring, which now rests against the bottom surface of the leg of T cross section ring, is compressed by pushing the rider upwards. The rider is then tilted to clear the bottom surface of the upper projection of the U cross section rider from the upper surface of the T cross section ring. The V shaped projection of the rider engages with a V shaped notch of the ring. Now the spring pressure is released and the both the upper and lower projection of the U cross section rider is contained in the top and bottom facing annulus of the T cross section ring.

After consuming 4, 8 or 16 ounce of water, the user pushes the rider upwards and the V shaped projection of the rider clears the V shaped notch of the ring and rests on the flat top surface of the ring and can be easily moved laterally to engage the next V shaped notch or a second notch representing the volume of liquid consumed. The spring tension pulls the rider downwards, locking the rider in place, secure from accidental displacement. When the user consumes 8 ounces of water, the rider must be moved by two notches.

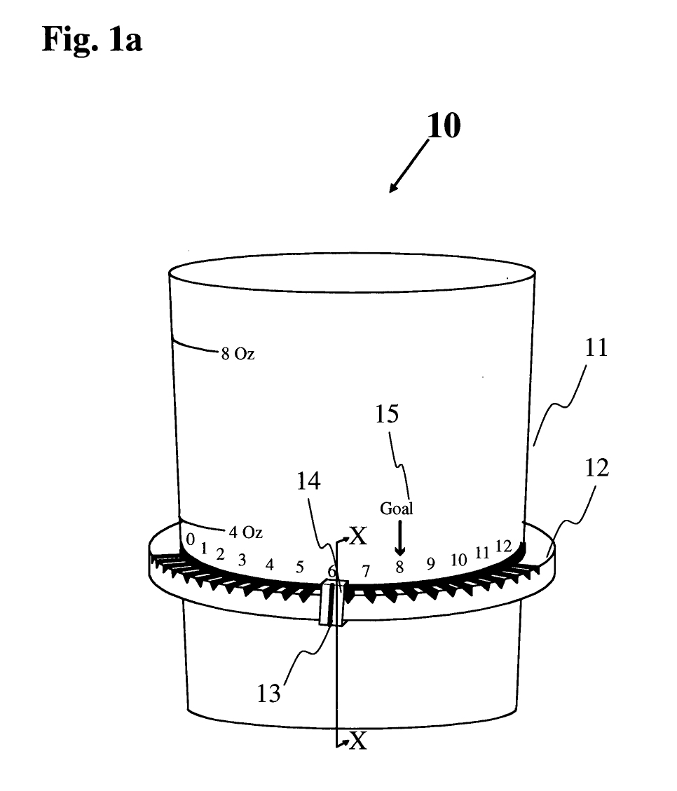

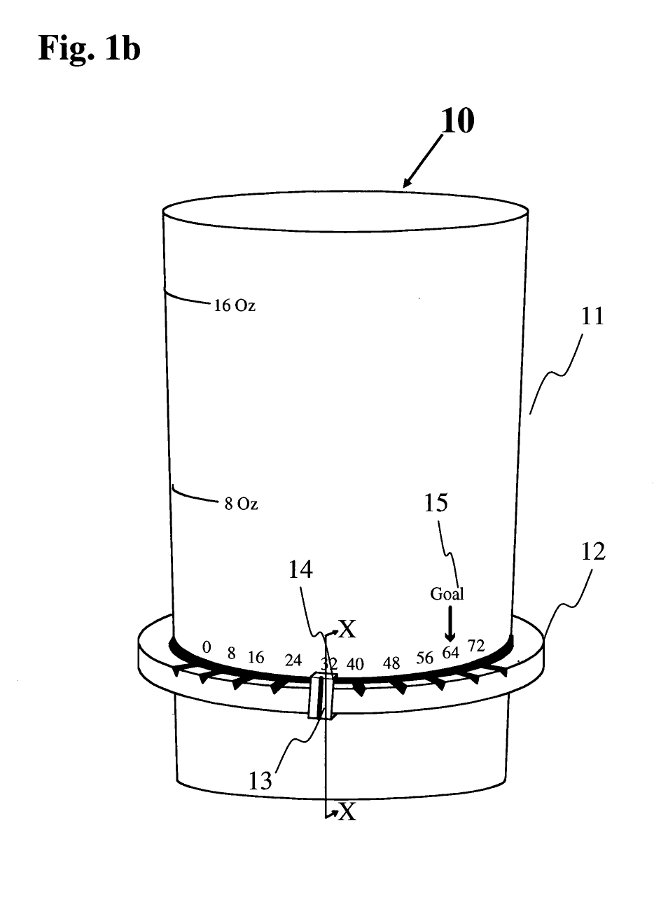

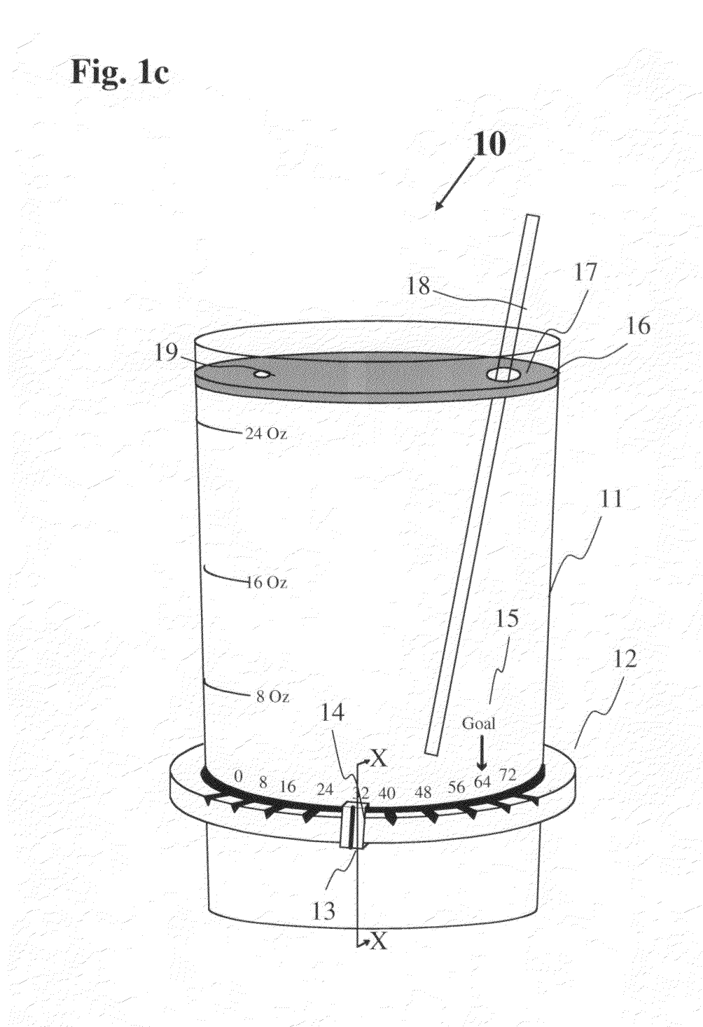

FIG. 1a shows at 10 a schematic view of a dieter's water intake quantity tracking glass showing the drinking glass 11 with 4 ounce and 8 ounce markers. The T cross section is ring integrally attached to the glass and is not rotatable or movable. The ring may be molded as a part of the manufacturing process of the drinking glass or molded as a separate part and attached to the glass using an adhesive. A U cross section rider 12 is placed on the ring and is displaced, one notch at a time, by the user based on the amount of water consumed. The user moves the rider by one notch after consumption of 4 ounces of water; or by two notches after consumption of 8 ounces of water. The marker 13 of the rider points towards the etched, embossed, raised or printed indicia 14 on the glass 11 outer surface which indicates the number of 8 ounce volume increments of water consumed. In this figure, the marker is shown to point to consumption of 6 cups, each of which contained 8 ounces of water. The printed indicia at 8 is marked as the goal and this represents consumption of 8 eight ounce glasses of water, and the user can at a glance recognize progress towards the water consumption goal. FIGS. 1a through 3b use corresponding numerical indicia for clarity.

FIG. 1b shows generally at 10 a schematic view of a dieter's water intake quantity tracking glass having a larger fluid volume capacity depicting the drinking glass 11 with 8-ounce and 16-ounce markers. The T cross section ring is integrally attached to the glass and is not rotatable or movable. The ring may be molded as a part of the manufacturing process of the drinking glass or molded as a separate part and attached to the glass using an adhesive. A U cross section rider 12 is placed on the ring and is displaced, one notch at a time, by the user based on the amount of water consumed. The user moves the rider by one notch after consumption of 8 ounces of water, or moves the rider by two notches after consumption of 16 ounces of water. The marker 13 of the rider points towards the etched, embossed, raised or printed indicia 14 on the outer surface of glass 11, which indicates the number of ounces of water consumed. In this figure, the marker is shown to point to consumption of 32 ounces of water. The printed indicia at 64 is marked as the goal, and this represents consumption of 8 eight ounce glasses of water allowing the user to discern at a glance the amount of progress towards the water consumption goal.

FIG. 1c shows generally at 10 a schematic view of a dieter's water intake quantity tracking glass having an even larger fluid volume capacity depicting the drinking glass 11 with 8-ounce, 16-ounce and 24 ounce markers. The glass has a closure lid 16 with an aperture 17 provided for insertion of straw 18 and a smaller second aperture 10 for entry of air into the enclosed portion of the drinking glass as water is drawn in through the straw. The T cross section ring is integrally attached to the glass and is not rotatable or movable. The ring may be molded as a part of the manufacturing process of the drinking glass or molded as a separate part and attached to the glass using an adhesive. A U cross section rider 12 is placed on the ring and is displaced, one notch at a time, by the user based on the amount of water consumed. The user moves the rider by one notch after consumption of 8 ounces of water, or moves the rider by two notches after consumption of 16 ounces of water. The marker 13 of the rider points towards the etched, embossed, raised or printed indicia 14 on the outer surface of glass 11, which indicates the number of ounces of water consumed. In this figure, the marker is shown to point to consumption of 32 ounces of water. The printed indicia at 64 is marked as the goal, and this represents consumption of 8 eight ounce glasses of water allowing the user to discern at a glance the amount of progress towards the water consumption goal.

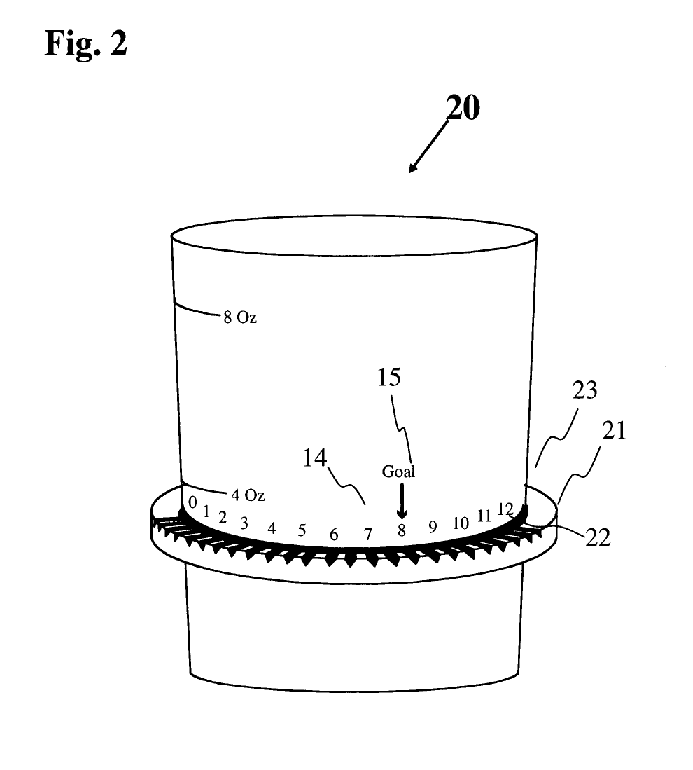

FIG. 2 illustrates generally at 20 a schematic view of the drinking glass with the integral T cross section ring 21 showing the notches 22 that are present its upper surface of the ring. As shown, the T cross section ring is bonded to the glass by the leg of the T and the wide portion of the T stands vertical, thus creating a channel or gap facing the top and the bottom of the glass. The upper surface 23 of the T section ring is provided with 25 V shaped notches corresponding to water consumption of 0 glasses through 12 glasses of 4 ounce volume. The glass outer surface at 14 shows the indicia of numerals that correspond to the number of 8 ounce water consumption. The half glass values are not marked for clarity.

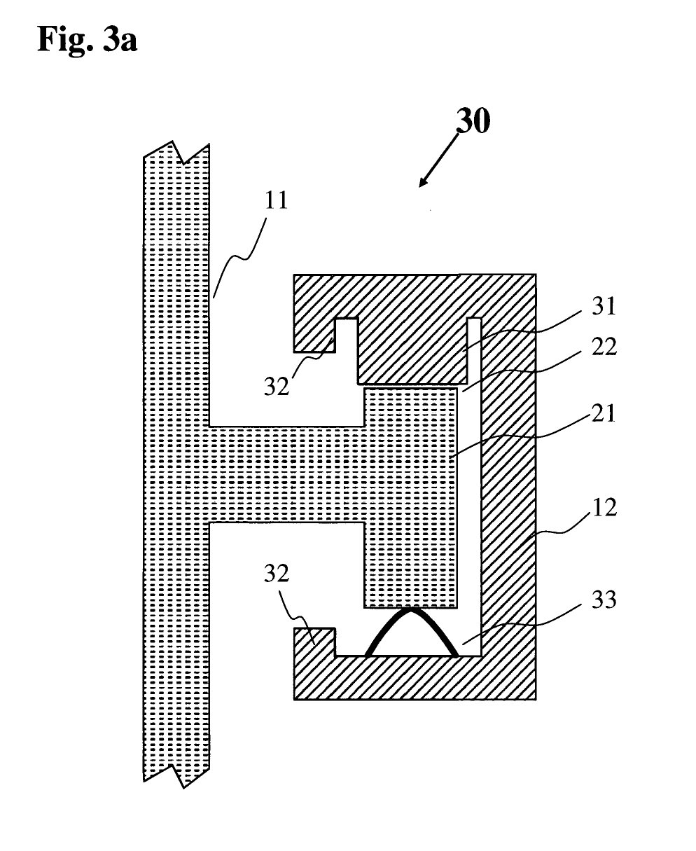

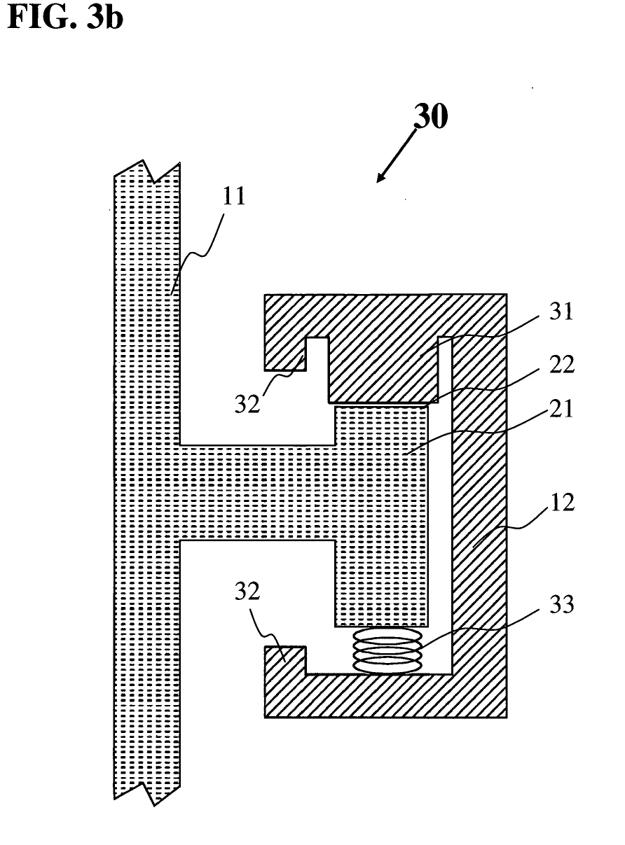

FIG. 3a illustrates at 30 a cross section along XX of FIG. 1. It shows the glass sidewall 11 with the T cross section ring 21 permanently attached to it. The V notch on the upper surface of the T cross section ring is shown at 22. The rider 12 is inserted over the T cross section ring 21 and the end projections of the rider is shown at 32. The V shaped projection 31 of the rider mating with a V shaped notch 22 of the T cross section ring. A bent metal spring 33 pushes the rider downwards engaging the V shaped projection 31 with the V shaped notch 22.

FIG. 3b illustrates at 30 a cross section along XX of FIG. 1. It shows the glass sidewall 11 with the T cross section ring 21 permanently attached to it. The V notch on the upper surface of the T cross section ring is shown at 22. The rider 12 is inserted over the T cross section ring 21 and the end projections of the rider are shown at 32. The V shaped projection 31 of rider mates with the V shaped notch 22 of the T cross section ring. In an alternate embodiment, a coil spring 33 pushes the rider downwards engaging the V shaped projection 31 with the V shaped notch 22.

The dieter's water intake quantity tracking glass comprises, in combination, the following salient features:
1. a drinking glass with 4 ounce and 8 ounce water level marks in the first embodiment;
2. a drinking glass with 8 ounce and 16 ounce water level marks in the second embodiment;
3. a drinking glass with 8 ounce, 16 ounce and 24 ounce water level marks in the second embodiment
4. said glass having an integrally attached T cross section ring near the bottom of the glass;
5. said T cross section ring having an upper surface that has a plurality of V shaped notches corresponding to 0 through 12 eight ounce glasses of water consumption, and intermediate V shaped notches for four ounce water consumption in the first embodiment;
6. said T cross section ring having an upper surface that has a plurality of V shaped notches corresponding to 0 through 72 ounces of water consumption in the second or third embodiment;
7. said glass having etched, embossed or printed indicia in line with said V shaped notches representing a number of eight ounces of water consumption in the first embodiment or the liquid volume consumed in ounces in the second embodiment;
8. a removable U cross section rider with a V shaped projection inserted over said T cross section ring engaging one of said V shaped notches;
9. a spring member attached to the bottom interior surface of said U cross section rider retaining the engagement of the rider's V shaped projection with the ring's V shaped notch, preventing accidental displacement of said rider;
10. said rider having a mark or pointer to indicate the volume of water consumed;
11. a user manually compressing the spring member and displacing said rider by one notch upon consumption of four ounces of water or by two notches upon consumption of eight ounces of water;
12. the glass optionally provided with a seal lid that has an aperture for the insertion of a straw and a second smaller aperture provided for the entry of air into the enclosed portion of the glass as water is drawn through the straw;
whereby the rider may be removed at any time to facilitate cleaning the of glass, and replaced at any of the notches without losing count, and the user is provided with information on the amount of water consumed during a 24-hour period by a drinking glass that is adapted to be contained in a cup holder of a car or an SUV, and which can reliably and accurately track water consumption over a prolonged period of time despite repeated cleaning in domestic or commercial dishwashers.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A dieter's water intake quantity tracking vessel, comprising:
a. a drinking vessel having water level marks indicating 4 ounces, 8 ounces, 16 or 24 ounces;
b. said vessel having an integrally attached T cross section ring near the bottom of the vessel;
c. said T cross section ring having an upper surface;
d. said upper surface that has plurality of V shaped notches corresponding to 0 through at least 8 eight ounce allotments of water consumption;
e. said vessel having indicia in line with said V shaped notches representing the number of eight ounce water allotments consumed;
f. a removable U cross section rider with a V shaped projection inserted over said T cross section ring engaging one of said V shaped notches;
g. a spring member attached to the bottom interior surface of said U cross section rider retaining the engagement of the rider's V shaped projection with the ring's V shaped notch, preventing accidental displacement of said rider;
h. said rider having a mark or pointer to indicate the volume of water consumed;
whereby a user manually compresses said spring member and displaces said rider by one notch or two notches upon consumption of water matching the number of cups or ounces of water consumed, thereby keeping track of the volume of water consumed during a 24-hour period.

2. A dieter's water intake quantity tracking vessel as recited by claim 1, wherein said T cross section ring is integrally attached to said drinking glass by adhesive attachment.

3. A dieter's water intake quantity tracking vessel as recited by claim 1, wherein the vessel has a plurality of liquid level markers designating 4 ounces and 8 ounces.

4. A dieter's water intake quantity tracking vessel as recited by claim 1, wherein the vessel has a plurality of liquid level markers designating 8 ounces and 16 ounces.

5. A dieter's water intake quantity tracking vessel as recited by claim 1, wherein the vessel has a plurality of liquid level markers designating 8 ounces, 16 ounces and 24 ounces.

6. A dieter's water intake quantity tracking vessel as recited by claim 1, wherein the vessel has indicia representing the number of eight ounce cups of water consumed.

7. A dieter's water intake quantity tracking vessel as recited by claim 1, wherein the vessel has indicia representing the ounces of water consumed.

8. A dieter's water intake quantity tracking vessel as recited by claim 3, wherein said upper surface of T cross section ring has a plurality of additional V shaped notches representing 4 ounce allotments of water consumption.

9. A dieter's water intake quantity tracking vessel as recited by claim 3, wherein said indicia represent the number of eight ounce cups of water consumed.

10. A dieter's water intake quantity tracking vessel as recited by claim 1, wherein vessel is a drinking glass and said indicia are etched thereon.

11. A dieter's water intake quantity tracking vessel as recited by claim 1, wherein said vessel is a drinking glass, and said indicia on glass are embossed thereon.

12. A dieter's water intake quantity tracking glass as recited by claim 1, wherein said vessel is a drinking glass, and said indicia thereon are raised print.

13. A dieter's water intake quantity tracking vessel as recited by claim 1, wherein said spring member pushes said rider downwards engaging said V shaped projection of said rider with said V shaped notch of T cross section ring, preventing accidental displacement of said rider.

14. A dieter's water intake quantity tracking vessel; as recited by claim 1, wherein said spring member is a bent metal spring.

15. A dieter's water intake quantity tracking vessel as recited by claim 1, wherein said spring member is a coil spring.

16. A dieter's water intake quantity tracking vessel as recited by claim 1, wherein said spring member is a corrosion resistant metallic spring.

17. A dieter's water intake quantity tracking vessel as recited by claim 1, wherein said spring member is a corrosion resistant polymeric spring.

18. A dieter's water intake quantity tracking vessel as recited by claim 1, wherein said rider is removed prior to cleaning of said drinking vessel at any time and is replaced at the same notch location to accurately keep track of volume of water consumed during a 24-hour period.

19. A dieter's water intake quantity tracking vessel as recited by claim 1, wherein said drinking vessel fits in a cup holder of a car or an SUV.

20. A dieter's water intake quantity tracking vessel as recited by claim 1, wherein the vessel has a close fitting lid that has a first aperture for the insertion of a water drinking straw and a second smaller aperture for entry of air into the enclosed space of the glass as water is drawn through the straw.

21. A procedure for using a dieter's water intake quantity tracking vessel, comprising the steps of:
a. setting a U cross section rider on a T cross section ring permanently attached to a drinking vessel at zero on the beginning of a 24-hour time period;
b. filling the drinking vessel with water to the 4 ounce level, 8 ounce level or 16 ounce level and drinking the water;
c. pressing said rider upwards by use of thumb or finger to thereby release a V shaped projection of said rider from a V shaped notch of the T cross section ring's upper surface;
d. manually advancing said rider by one notch for the consumption of a 4 ounce cup of water or by a number of notches matching the number of eight ounce cups of water consumed;
e. removing the rider at any time to clean the drinking glass and replacing said rider at the same notch, thereby keeping track of the total volume of water consumed;
whereby a spring within said rider engages said V shaped projection of said rider with said V shaped notch of the T cross section ring at all times, preventing accidental displacement of said rider.
